(19) United States
(12) Patent Application Publication
(10) Pub. No.: US 2015/0255227 A1
(43) Pub. Date: Sep. 10, 2015

(54) SELF-HEALING COMPOSITE, SELF-HEALING SUPERCAPACITOR AND METHODS OF FABRICATION THEREOF

(71) Applicant: Nanyang Technological University, Singapore (SG)

(72) Inventors: Xiaodong CHEN, Singapore (SG); Hua WANG, Singapore (SG)

(21) Appl. No.: 14/639,552

(22) Filed: Mar. 5, 2015

Related U.S. Application Data
(60) Provisional application No. 61/948,188, filed on Mar. 5, 2014.

(51) Int. Cl. H01G 11/36; H01G 11/86; H01G 11/26; H01G 11/56; C08G 69/48; H01G 11/52

(52) U.S. Cl. CPC H01G 11/36; C08G 69/48; H01G 11/52; H01G 11/26; H01G 11/56; H01G 11/86

(57) ABSTRACT

There is provided a self-healing composite including a supramolecular polymeric network of molecules cross-linked through reversible bonds, and nanostructures incorporated into the supramolecular polymeric network, the nanostructures and the supramolecular polymeric network being cross-linked through reversible bonds. In particular, the supramolecular network has a glass transition temperature (Tg) of about 10° C. to about 50° C. There is also provided a self-healing supercapacitor incorporating the self-healing composite and an electrode incorporating the self-healing composite.

### CROSS-REFERENCE TO RELATED APPLICATION

This application claims the benefit of priority of U.S. Provisional Application No. 61/948,188, filed 5 Mar. 2014, the contents of which being hereby incorporated by reference in its entirety for all purposes.

### TECHNICAL FIELD

The present invention generally relates to a self-healing composite, a self-healing supercapacitor incorporating the self-healing composite, and methods of fabrication thereof.

### BACKGROUND

Supercapacitors, a promising class of energy storage devices, are drawing much attention due to their fast charge and discharge rates, high power density, and long cycle lifetimes. Most of the current research on supercapacitors is focused on fabricating novel electrode materials with higher capacitance, and constructing unique configurations for greater compatibility with various device architectures. In particular, to meet the requirements of growing development of portable electronic devices, great efforts have been devoted to flexible, lightweight, and miniaturized supercapacitors. However, when most of these supercapacitors are subjected to practical application, the electrode materials become susceptible to structure fractures under bending or during charge and discharge process, while the polymeric flexible substrates may possibly undergo mechanical damage caused by deformation over time or accidental cutting. Both of these failures would seriously limit the reliability and lifetime of the supercapacitors, resulting in the whole scale breakdown of the electronic devices, generation of abundant electronic waste, inconvenience, as well as safety hazards.

Thus, the ideal supercapacitor should not only retain high capacitance and portability, but also be endowed with impressive properties such as the capability to prevent the structural fractures of electrode materials, or to restore the devices' configuration integrity and electrical properties after mechanical damage. As current research comprises striking omissions in the mechanical sustainability of these supercapacitors, it should be of scientific and technological importance to explore robust supercapacitors with the capability for damage management.

Self-healing materials, which can repair the internal or external damages that they have sustained, have been developed over the past decade. Besides the ability to restore mechanical and structural properties after damage, the recovery of function is also a characteristic of emphasis for research in these materials. In addition, further progress in fabrication of integrated functional devices with self-healing attribute remains a challenge. For example, to achieve a functional supercapacitor capable of damage self-healing, the restoration of electrical conductivity after damage is of foremost importance.

Integrated functional devices based on existing self-healing materials need to be further improved. For example, there has been disclosed a healable device using a healable electrical conductive film as an electrode, which can be achieved by depositing Ag nanowires (AgNWs) on top of healable PEM films. When a mechanical damage occurs, deionized water is required to be dropped at the damaged site to enable healing and the lateral movement of the underlying layer brings separated areas of the AgNW layer into contact, thus restoring its conductivity. In addition, there has been disclosed a self-healing device with a supramolecular polymeric hydrogen-bonding network containing homogeneously dispersed nickel microparticles, which can realize the self-healing property by increasing the temperature of the device to 110° C. However, the use of water in the device could introduce problems such as shorting and water leakage, and the application of a high temperature could damage the device while increasing the fabrication costs and complexity.

A need therefore exists to provide a self-healing composite and a self-healing capacitor with self-healing attribute, including the restoration of configuration integrity and electrical properties after mechanical damage (e.g., deformation over time or accidental cutting), and which seek to overcome, or at least ameliorate, one or more of the deficiencies of the prior art mentioned above. It is against this background that the present invention has been developed.

### SUMMARY

According to a first aspect of the present invention, there is provided a self-healing composite comprising:
a supramolecular polymeric network of molecules cross-linked through reversible bonds; and
nanostructures incorporated into the supramolecular polymeric network, the nanostructures and the supramolecular polymeric network being cross-linked through reversible bonds,
wherein the supramolecular network has a glass transition temperature of about 10° C. to about 50° C.

Preferably, the nanostructures comprise flower-like nanostructures.

Preferably, the nanostructures are made of TiO₂, SiO₂, or Ni.

Preferably, the amount of nanostructures in the supramolecular polymeric network is about 45 wt % to about 53 wt %.

Preferably, the amount of nanostructures in the supramolecular polymeric network is about 47 wt %.

Preferably, the reversible bonds are selected from the group consisting of hydrogen bonds, host-guest interaction, π-π interaction, and hydrophobic interaction.

Preferably, the reversible bonds between the nanostructures and the supramolecular polymeric network based on carbonyl functional groups and/or NH functional groups from the supramolecular polymeric network.

According to a second aspect of the present invention, there is provided a self-healing supercapacitor comprising:
a first electrode comprising a first substrate and a first conductive film disposed on the first substrate;
a second electrode comprising a second substrate and a second conductive film disposed on the second substrate; and
a separating layer disposed between the first and second electrodes,
wherein at least one of the first and second substrates comprises a self-healing composite including:
   a supramolecular polymeric network of molecules cross-linked through reversible bonds; and
   nanostructures incorporated into the supramolecular polymeric network, the nanostructures and the supramolecular polymeric network being cross-linked through reversible bonds,
   wherein the supramolecular network has a glass transition temperature of about 10° C. to about 50° C.

Preferably, the nanostructures comprise flower-like nanostructures.

Preferably, the first and second conductive films each comprises elongated nanostructures dispersed on the respective first and second substrates.

Preferably, the elongated nanostructures are selected from the group consisting of carbon nanowires, carbon nanotubes and carbon nanorods.

Preferably, the separating layer comprises a gel polymer electrolyte configured to bond the first and second conductive films together and provide a conductive connection between the first and second electrodes.

Preferably, the gel polymer electrolyte is selected from the group consisting of polyvinyl pyrrolidone-sulphuric acid (PVS-H₂SO₄), poly(ethylene oxide)-LiBF₄, and poly(acrylonitrile)-LiClO₄.

According to a third aspect of the present invention, there is provided a method of fabricating a self-healing composite, the method comprising:
forming a supramolecular polymeric network of molecules cross-linked through reversible bonds; and
incorporating nanostructures into the supramolecular polymeric network and cross-linking the nanostructures and supramolecular polymeric network through reversible bonds,
wherein the supramolecular network has a glass transition temperature of about 10° C. to about 50° C.

Preferably, the nanostructures comprise flower-like nanostructures.

Preferably, the nanostructures are made of TiO₂, SiO₂, or Ni.

Preferably, the amount of nanostructures in the supramolecular polymeric network is about 45 wt % to about 53 wt %.

Preferably, the amount of nanostructures in the supramolecular polymeric network is about 47 wt %.

Preferably, the reversible bonds are selected from the group consisting of hydrogen bonds, host-guest interaction, π-π interaction, and hydrophobic interaction.

Preferably, the reversible bonds between the nanostructures and the supramolecular polymeric network are based on carbonyl functional groups and/or NH functional groups from the supramolecular polymeric network.

According to a fourth aspect of the present invention, there is provided a method of fabricating a self-healing supercapacitor, the method comprising:
forming a first electrode comprising a first substrate and a first conductive film disposed on the first substrate;
forming a second electrode comprising a second substrate and a second conductive film disposed on the second substrate; and
forming a separating layer disposed between the first and second electrodes, wherein at least one of the first and second substrates comprises a self-healing composite comprising:
   a supramolecular polymeric network of molecules cross-linked through reversible bonds; and
   nanostructures incorporated into the supramolecular polymeric network, the nanostructures and the supramolecular polymeric network being cross-linked through reversible bonds,
   wherein the supramolecular network has a glass transition temperature of about 10° C. to about 50° C.

According to a fifth aspect of the present invention, there is provided an electrode comprising:
a self-healing substrate; and
a conductive film disposed on the self-healing substrate;
wherein the self-healing substrate comprises a self-healing composite including:
   a supramolecular polymeric network of molecules cross-linked through reversible bonds; and
   nanostructures incorporated into the supramolecular polymeric network, the nanostructures and the supramolecular polymeric network being cross-linked through reversible bonds,
   wherein the supramolecular network has a glass transition temperature of about 10° C. to about 50° C.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 schematically depicts an exemplary structure of a self-healing composite according to an embodiment of the present invention;

FIG. 2 depicts a schematic thawing of an exemplary self-healing supercapacitor according to an embodiment of the present invention;

FIG. 3 depicts an overview of a method of fabricating a self-healing composite according to an embodiment of the present invention;

FIG. 4 depicts an overview of a method of fabricating a self-healing supercapacitor according to an embodiment of the present invention;

FIG. 5 depicts a schematic flow diagram of a method of fabricating an integrated self-healing supercapacitor device according to an example embodiment of the present invention;

FIGS. 6a and 6b depict SEM images of the nanoflowers at 50,000 times magnification and 120,000 times magnification, respectively;

FIGS. 6c and 6d depict a TEM image and an XRD pattern of the nanoflowers, respectively;

FIGS. 7a to 7d illustrate the mechanical strength and flexibility of a self-healing composite having a thickness of about 1 mm;

FIGS. 8a and 8b depict the optical and SEM images (at 80,000 times magnification) of an as-prepared functionalized SWCNT film in an example embodiment of the present invention;

FIGS. 9a and 9b illustrate a flexible and mechanically free-standing self-healing composite having a thickness of 3 mm with 47 wt % TiO₂ nanoflowers according to an example embodiment;

FIGS. 10a to 10c show the cross-sectional SEM images of self-healing composites with different added amount of TiO₂ nanoflowers (38 wt %, 47 wt % and 53 wt %, respectively), in an experiment conducted;

FIG. 11 depicts a graph of the tensile measurements of self-healing composites with different TiO₂ weight ratios (38 wt %, 47 wt %, 53 wt %), and healed samples with different healing temperatures (25° C. and 50° C.) for a 47 wt % TiO₂ composite in an experiment conducted;

FIG. 12 depicts a graph of the High-resolution ¹H Nuclear Magnetic Resonance (NMR) spectra of the supramolecular network on the reaction between the randomly branched polymer and urea at different reaction times in an experiment conducted;

FIG. 13 depicts a graph of the differential scanning calorimetry (DSC) spectra of two as-prepared self-healing composites, one with added 47 wt % TiO₂ nanoflowers and the other one without any TiO₂ nanoflowers, in an experiment conducted;

FIGS. 14a to 14d depict images of a self-healing composite at various stages to illustrate its self-healing property in an experiment conducted;

FIG. 15 depicts a cross-sectional SEM image of a self-healing substrate having deposited thereon a functionalized SWCNT film according to an example embodiment of the present invention;

FIGS. 16a to 16c depict images illustrating the conductivity behaviour of an example electrode (having an underlying self-healing composite layer) according to an embodiment of the present invention;

FIG. 17 depicts the I-V curves of an electrode (having an underlying self-healing composite layer) in an experiment conducted;

FIG. 18 depicts schematic drawings of the electrode at various stages to demonstrate its self-healing property; and

FIGS. 19a to 19f depict various electrochemical measurements of the as-prepared self-healing supercapacitor according to embodiments of the present invention in various experiments conducted.

### DETAILED DESCRIPTION

Embodiments of the present invention provide a self-healing composite which can be incorporated into various electronic devices (such as incorporated in an electrode of the electronic device) for enabling such electronic devices to have self-healing attribute, including the restoration of configuration integrity and electrical properties after mechanical damage (e.g., deformation over time or accidental cutting). As a preferred embodiment, an integrated supercapacitor device incorporating the self-healing composite will be specifically described herein in detail later. However, it will be appreciated to a person skilled in the art that the self-healing composite disclosed according to embodiments of the present invention is not limited to being applied in a supercapacitor device and may also be applied to other electronic devices so that they may also possess self-healing attribute, such as self-healing batteries.

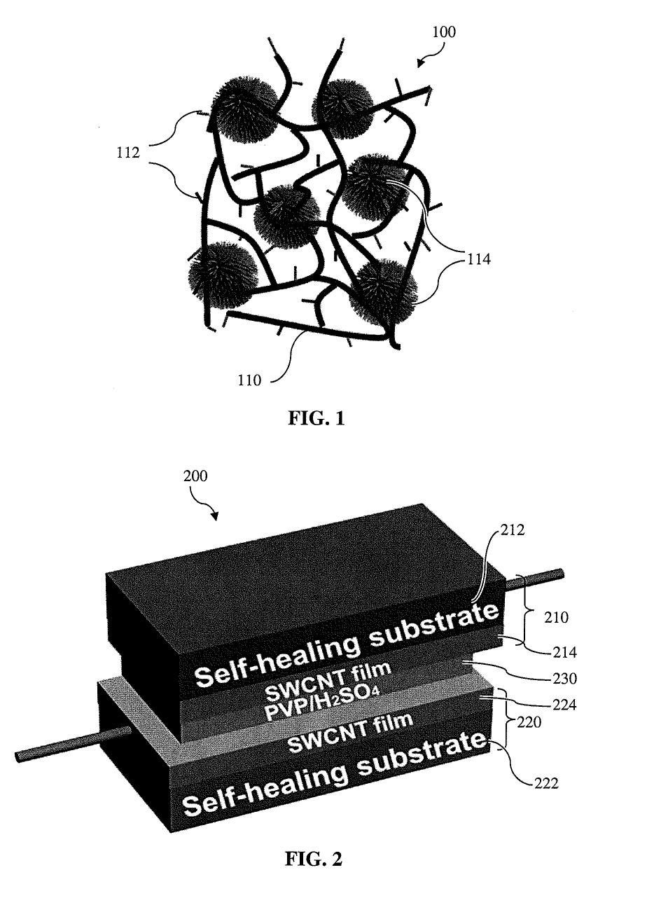

FIG. 1 schematically depicts an exemplary structure of a self-healing composite 100 according to an embodiment of the present invention. As illustrated, the self-healing composite 100 comprises a supramolecular polymeric network 110 of molecules cross-linked through reversible bonds 112, and nanostructures 114 incorporated into the supramolecular polymeric network 110, the nanostructures 114 and the supramolecular polymeric network 110 being cross-linked through reversible bonds 112. In particular, the supramolecular network 110 is configured to have a glass transition temperature (Tg) below ambient/room temperature (preferably, around 10° C. to 50° C.).

By configuring the supramolecular network 110 to have a glass transition temperature below room temperature, the reversible bonds 112 are advantageously able to dynamically associate at room temperature thus endowing the composite 100 with excellent healing capability even at room temperature. Incorporating nanostructures 114 into the supramolecular polymeric network 110 and cross-linking the nanostructures 114 and the supramolecular network 110 through reversible bonds 112 according to embodiments of the present invention advantageously enhance the mechanical strength and the glass transition temperature of the supramolecular polymeric network 110. The increase in the mechanical strength allows the supramolecular polymeric network 110 to better hold its shape and thus able to function as an effective substrate for various applications such as in an electrode.

As will be explained and demonstrated later, the self-healing composite 100 is able to substantially restore its mechanical strength and flexibility after a mechanical damage even at room temperature, without requiring the use of external stimuli such as deionized water or heat at a high temperature. In the embodiment, the self-healing composite 100, having a low glass transition temperature of about 10° C. to 50° C., is achieved through the assembly of molecules to form both chains and cross-links via a large amount of hydrogen bond acceptors and donors, which are also able to dynamically associate at room temperature and manifest as a self-healing property by bringing together fractured surfaces in the event of a cut or breakage.

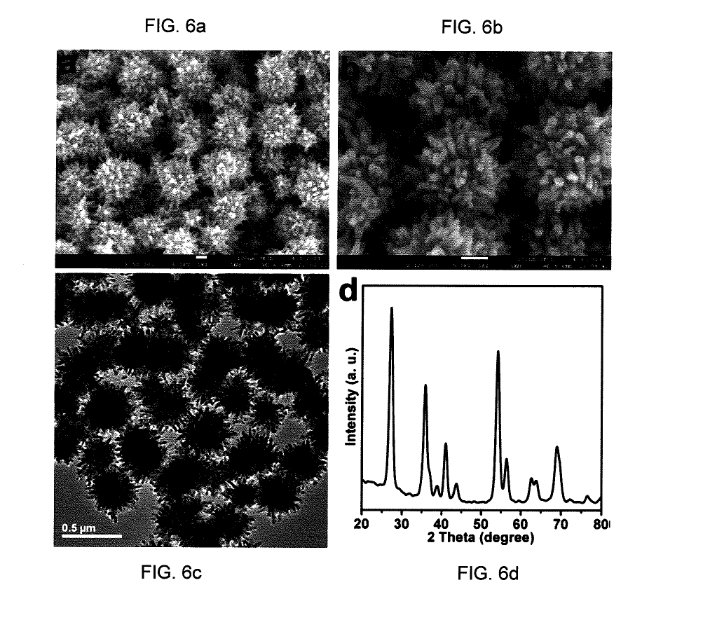

In a preferred embodiment, the nanostructures 114 incorporated into the supramolecular network 110 are hierarchical flower-like nanostructures (or nanoflowers) as illustrated in FIGS. 1 and 6. It will be appreciated to a person skilled in the art that shape of the nanostructures 114 shown may also be described in other terms as appropriate such as spiked nanostructure (or spiked-nanospheres). The interaction between the nanoflowers 114 introduced and the supramoleculars by hydrogen bonds was able to sufficiently hold the shape of supramolecular network 110 and thus enhances its mechanical strength. Although nanoflowers 114 are preferred in embodiments of the present invention as they were found to produce excellent results, other types of nanostructures (in addition to or alternatively) may also as appropriate. For example, suitable types of nanostructures preferably possess the following properties: 1) the nanostructures 114 should be able to interact with the supramolecular oligomers (e.g., the nanoflowers are able to provide an affinity for hydrogen bonds in the synthesized supramolecular network 110); 2) the nanostructures 114 should provide the supramolecular network 110 with high mechanical strength. For example, when the tensile strain of self-healing substrate (including 47% nanostructures 114) reached 40%, its tensile stress can preferably reach 0.11 MPa; 3) the nanostructures 114 should have large surface areas to maximize interaction with the supramolecular oligomers. It was surprisingly found that the inclusion of such nanostructures enable the self-healing composite 100 to hold its shape, thus enhancing its mechanical strength and making it suitable to function as an effective substrate.

By way of examples only, other suitable types of nanostructures 114 may include nanospheres, nanorods, nanowires, nanotubes. It was found that different morphology of the nanostructures 114 affects the mechanical strength of the self-healing substrate. In a further embodiment, conductive nano or micro-materials (not shown) such as Ni nano- or micro-particles may be added into the supramolecular network 110. As a result, the performance of the self-healing composite 100 was found to further improve.

In a preferred embodiment, the nanostructures 114 are made of titanium dioxide (TiO₂). In other embodiments, the nanostructures 114 may be made of Ni or SiO₂, or a combination of the above-mentioned materials.

In a preferred embodiment, the amount of nanostructures incorporated into the supramolecular polymeric network 110 is around 45 wt % to about 53 wt %. In particular, it was found that no phase aggregation could be observed when the amount of added nanostructures 114 was increased up to 53 wt %. It was also found that increasing the amount of nanostructures 114 incorporated into the supramolecular network 110 increases the mechanical strength and Young's modulus. Accordingly, in various embodiments, the amount of nanostructures 114 incorporated into the supramolecular polymeric network 110 is configured to be around 45 wt % to around 50 wt %, around 46 wt % to around 49 wt %, and around 47% wt %. In an embodiment, a self-healing composite 100 comprising 47% TiO₂ nanoflowers 114 was found to provide an optimal balance between mechanical strength, flexibility and healing.

In the supramolecular network 110, the molecules are cross-linked through reversible bonds 112. In particular, an associative functional group of one molecule interacts with an associative functional group of another molecule to provide intermolecular bonds or links between the molecules, thereby forming the supramolecular network 110. In the cross-linked polymeric network 110, molecules interact with one another through their associative functional groups by reversible, relatively weak bonds, such as non-covalent bonds. In a preferred embodiment, the non-covalent bonds between molecules are hydrogen bonds. Although preferred, it will be appreciated to a person skilled in the art that the reversible bonds are not limited to being non-covalent bonds or hydrogen bonds, and other types of reversible bonds may occur such as host-guest interaction, π-π interaction, and hydrophobic interaction.

Similarly, molecules in the supramolecular network 110 interact with the nanostructures 114 through their associative functional groups by reversible, relatively weak bonds 112, such as non-covalent bonds as described above. In an embodiment, the reversible bonds 112 between the nanostructures and the supramolecular polymeric network are based on carbonyl functional groups and/or NH functional groups from the supramolecular network 110.

As a non-limiting example, the molecules in the supramolecular network 110 may be Empol 1016, which includes 4 wt % monoacid, 80 wt % diacids and 16 wt % triacids.

With the above configuration, the supramolecular network 110 possesses excellent self-healing attributes in the event of a mechanical damage (e.g., cuts, breakages or cracks) even at room temperature without requiring the application of deionized water or subjecting the composite 100 to a high temperature. In particular, the reversible bonds 112 between the molecules and the nanostructures may break upon being subjected to mechanical damage. However, such broken reversible bonds 112 can dynamically associate at the broken site without requiring external stimuli such as deionized water or heat, thereby healing the composite 100.

A supercapacitor 200 made to be self-healing by incorporating the self-healing composite 100 as described hereinabove will now be described according to a preferred embodiment of the present invention. However, as explained above, it will be appreciated to a person skilled in the art that the present invention is not limited to a supercapacitor and other electronic devices may also be made to be self-healing by incorporating the self-healing composite.

FIG. 2 depicts a schematic drawing of an exemplary self-healing supercapacitor 200 according to an embodiment of the present invention. As shown, the self-healing supercapacitor 200 comprises a first electrode 210 comprising a first substrate 212 and a first conductive film 214 disposed on the first substrate 212, a second electrode 220 comprising a second substrate 222 and a second conductive film 224 disposed on the second substrate 222, and a separating layer 230 disposed between the first and second electrodes 210, 220. In particular, at least one of the first and second substrates 212, 222 comprises the self-healing composite 100 as described hereinabove with reference to FIG. 1. Preferably, both the first and second substrates 212, 222 comprise the self-healing composite 100 so that both electrodes 210, 220 possess self-healing attribute.

In a preferred embodiment, the first and second conductive films 214, 224 each comprises elongated nanostructures (not shown in FIG. 2) dispersed on the respective first and second substrates 212, 222. In various embodiments, the elongated nanostructures are selected from the group consisting of carbon nanowires, carbon nanotubes, and carbon nanorods. Preferably, the separating layer 230 comprises a gel polymer electrolyte configured to bond the first and second conductive films 214, 224 together and provide a conductive connection between the first and second electrodes 210, 220. The gel polymer electrolyte may be selected from the group consisting of polyvinyl pyrrolidone-sulphuric acid (PVS-H₂SO₄), poly(ethylene oxide)-LiBF₄, or poly(acrylonitrile)-LiClO₄ system.

By making the electrodes 210, 220 with the self-healing composite 100 as described above, the configuration and conductivity of the electrodes 210, 220 may be restored if subjected to mechanical damage such as caused by deformation over time or accidental cutting. In particular, since the conductive film 214, 224 is formed on the self-healing substrate 212, 222 composed of the self-healing composite 100, upon being subjected to mechanical damage causing a separation (e.g., a crack or cut) in the electrode, lateral movement of the self-healing substrate 212, 222 (on which the conductive film 214, 224 is disposed) functions to bring the separated portions/areas of the conductive film 214, 224 back into contact, hence restoring the electrode's configuration and electrical conductivity. This advantageously results in a self-healing supercapacitor 200 exhibiting excellent electrochemically self-healing performance.

According to an embodiment, there is provided a method 300 of fabricating a self-healing composite 100 as shown in FIG. 3. The method 300 comprises a step 302 of forming a supramolecular polymeric network 110 of molecules cross-linked through reversible bonds 112, and a step 304 of incorporating nanostructures 114 into the supramolecular polymeric network 110 and cross-linking the nanostructures 114 and supramolecular polymeric network 110 through reversible bonds 112. In particular, the supramolecular network 110 is configured to have a glass transition temperature (Tg) below ambient/room temperature, preferably about 10° C. to about 50° C.

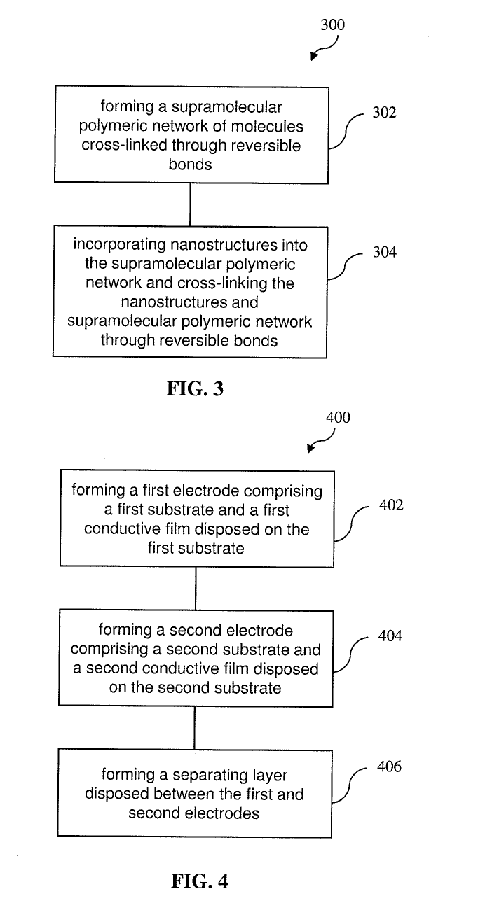

According to another embodiment, there is provided a method 400 of fabricating a self-healing supercapacitor 200 as shown in FIG. 4. The method 400 comprises a step 402 of forming a first electrode 210, 220 comprising a first substrate 212 and a first conductive film 214 disposed on the first substrate 212, a step 404 of forming a second electrode 220 comprising a second substrate 222 and a second conductive film 224 disposed on the second substrate 222, and a step 406 of forming a separating layer 230 disposed between the first and second electrodes 210, 220. In particular, at least one of the first and second substrates 212, 222 is formed to comprise a self-healing composite 100 as described hereinabove with reference to FIG. 1.

Hereinafter, the present invention will be described more fully with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, lengths and sizes of layers and regions may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

The self-healing supercapacitor 200 will now be described in further details according to an example embodiment of the present invention. In the example embodiment, the electrodes 210, 220 are fabricated by spreading single-walled carbon nanotube (SWCNT) films onto self-healing substrates 212, 222. Upon being subjected to mechanical damage, lateral movement of the self-healing composite layer 212, 222 brings the separated areas of the SWCNT layer 214, 224 into contact, hence enabling the restoration of the device's configuration and conductivity. In an experiment, a prototype of the supercapacitor 200 was made and tested for performance. It was found that the prototype exhibited excellent electrochemically self-healing performance, and the specific capacitance can be restored up to 85.7% of its original value even after the 5^{th} cutting. Such a characteristic may not only remarkably prolong the lifetime of electronic devices such as energy storage devices, but also empower them with desirable economic and human safety attributes.

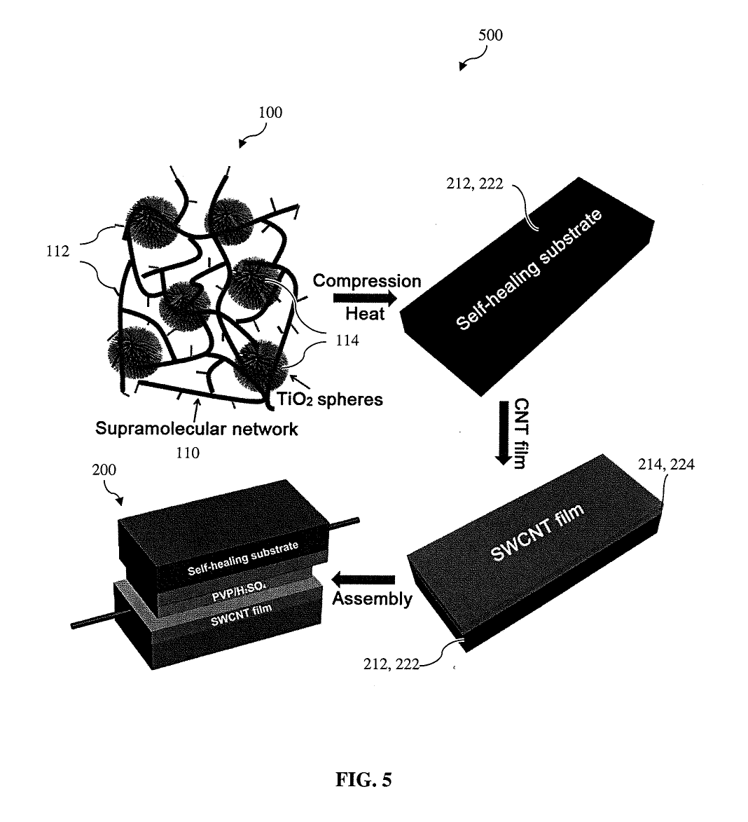

FIG. 5 depicts a schematic flow diagram of a method 500 of fabricating an integrated self-healing supercapacitor device 200 according to an example embodiment of the present invention. The self-healing substrates 212, 222 are composed of a supramolecular network 110 with a low glass transition temperature (Tg) below room temperature and hierarchical flower-like TiO₂ nanostructures 114. This is achieved through the assembly of supramolecules to form both chains and cross-links via a large amount of hydrogen bond acceptors and donors 112, which are also able to dynamically associate at room temperature (preferably, around 10° C. to 50° C.) and manifest as a self-healing property by bringing together fractured surfaces in the event of a cut or breakage.

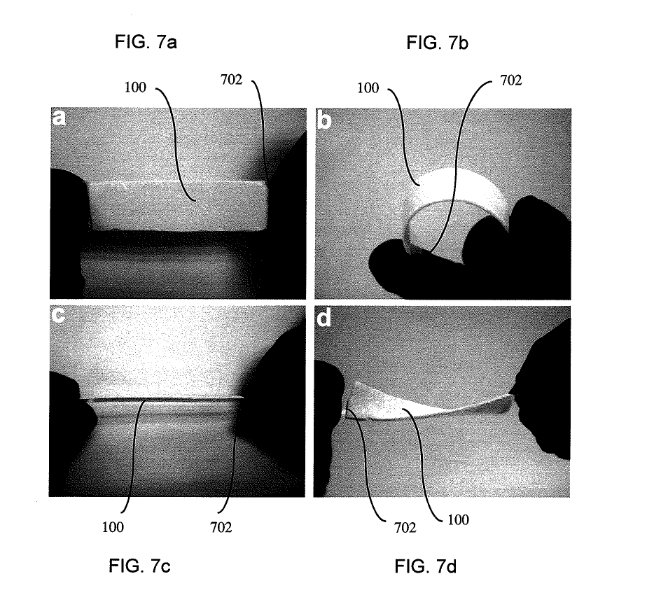

In the example embodiment, the rutile flower-like TiO₂ nanospheres 114, with an average size about 400 nm, were uniformly dispersed and incorporated into the as-synthesized supramolecular oligomers 110 by vigorous mechanical stirring, followed by thermal crosslinking with urea. For illustration purposes only, FIGS. 6a and 6b depict SEM images of the nanoflowers 114 at 50,000 times magnification and 120,000 times magnification, respectively. FIG. 6c depicts a TEM image and FIG. 6d depicts an XRD pattern of the nanoflowers 114. The interaction, between TiO₂ nanospheres 114 and supramoleculars by hydrogen bonds 112, was found to sufficiently hold the shape of the supramolecular network 110 and enhances its Tg from −35° C. to 20° C. Due to the reversible hydrogen bonds 112, the self-healing composite 100 can be thermally compressed and self-adhered on various hydrophilic substrates, such as flexible polyethylene terephthalate (PET) or oxygen plasma-activated poly(dimethylsiloxane) (PDMS) sheets 702. For illustration purposes only, FIGS. 7a to 7d illustrate the mechanical strength and flexibility of a self-healing composite 100 having a thickness of about 1 mm as an example. As shown, the self-healing composite 100 is able to bend and twist without causing any structural breakdown such as cracks.

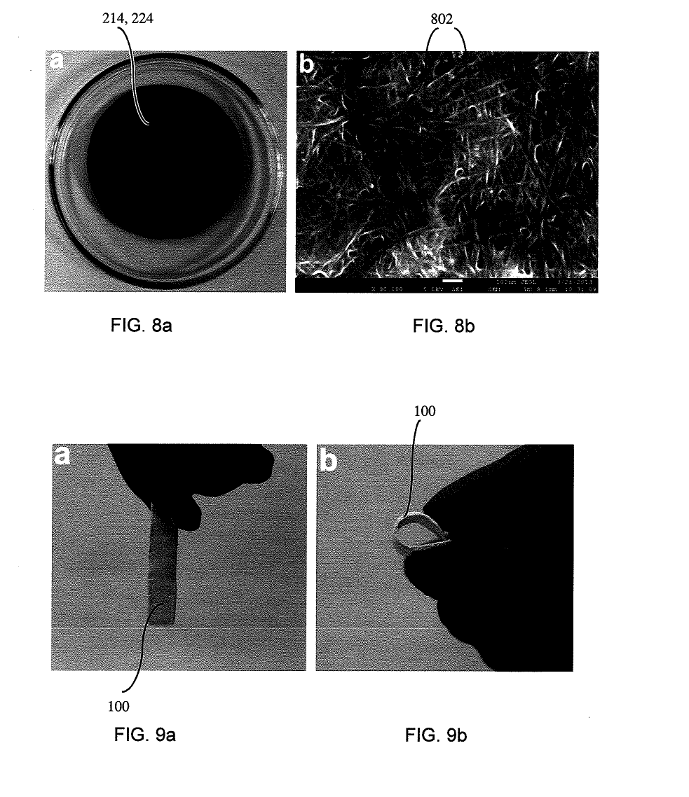

Next, an acid treated SWCNT film 214, 224, with a large amount of carboxylic and hydroxyl group grafted on the surface of the SWCNTs 802, were uniformly spread out and firmly adhered onto the self-healing substrates 212, 222. For illustration purposes only, FIGS. 8a and 8b depict the optical and SEM images (at 80,000 times magnification) of the as-prepared functionalized SWCNT films 214, 224 in an example. Then, an integrated supercapacitor device 200 was fabricated in which SWCNT films 214, 224 serve as the active materials and current collectors, while the PVP-H₂SO₄ gel polymer electrolyte 230 serves as both electrolyte and separator. With this configuration when damaged, lateral movement of the underlying self-healing composition layer 212, 222 brings the separated portions/areas of the SWCNT layer 214, 224 into contact, and enables restoration of its electrical conductivity. In addition, PVP gel is a self-adhering material and can also self-heal to some extent. As a result, the as-assembled supercapacitor 200 advantageously exhibits excellent healing capability even at room temperature and without requiring the use of external stimuli such as deionized water or heat.

The characteristics of the self-healing composite 100 will now be described in further details. It is of interest to note that although the composite 100 is self-adhesive under room temperature, it is flexible and mechanically free-standing at a suitable thickness. As an illustration, FIGS. 9a and 9b demonstrate a flexible and mechanically free-standing self-healing composite 100 having a thickness of 3 mm with 47 wt % TiO₂ nanoflowers.

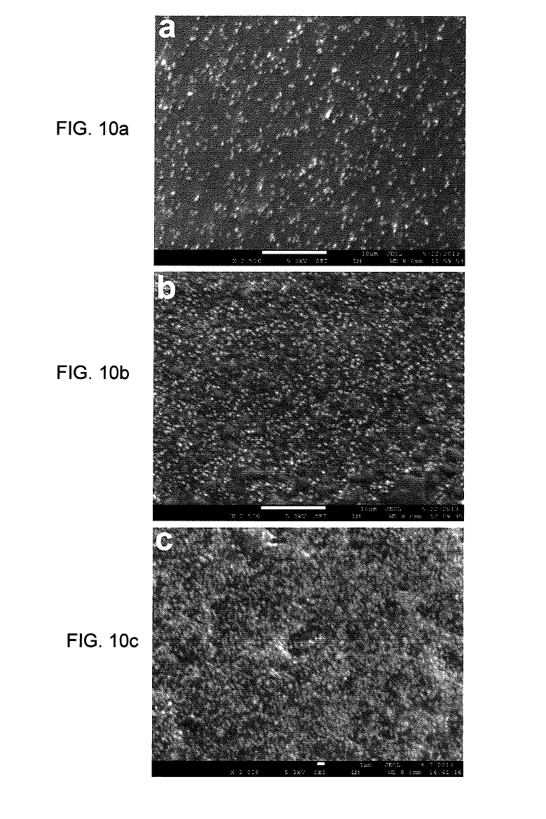

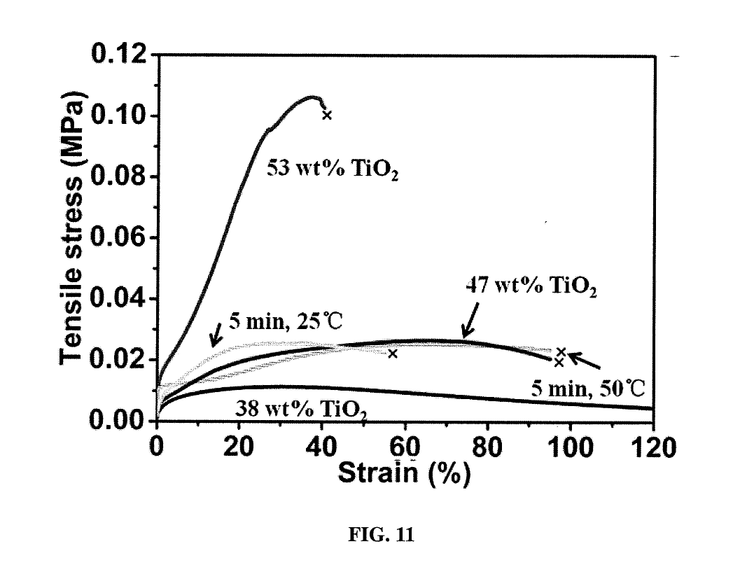

FIGS. 10a to 10c show the cross-sectional SEM images of the self-healing composite 100 with different added amount of TiO₂ nanoflowers 114, in particular, 38 wt %, 47 wt % and 53 wt %, respectively, in an experiment. Based this experiment conducted with different added amount of TiO₂ nanoflowers 114, it was surprisingly found that no phase aggregation was observed when the amount of added TiO₂ nanoflowers 114 was increased up to 53 wt % as illustrated in FIG. 10c, while a clear increase was observed in the mechanical strength and Young's modulus as shown in FIG. 11. In particular, FIG. 11 depicts a graph of the tensile measurements of self-healing composites 100 with different TiO₂ weight ratios (38 wt %, 47 wt %, 53 wt %), and the healed samples with different healing temperatures (25° C. and 50° C.) for 47 wt % TiO₂ composite. Therefore, in a preferred embodiment, the self-healing composite 100 is fabricated to comprise about 47 wt % TiO₂ 114 as it was found to provide an optimal balance between substrate mechanical strength, flexibility, and healing.

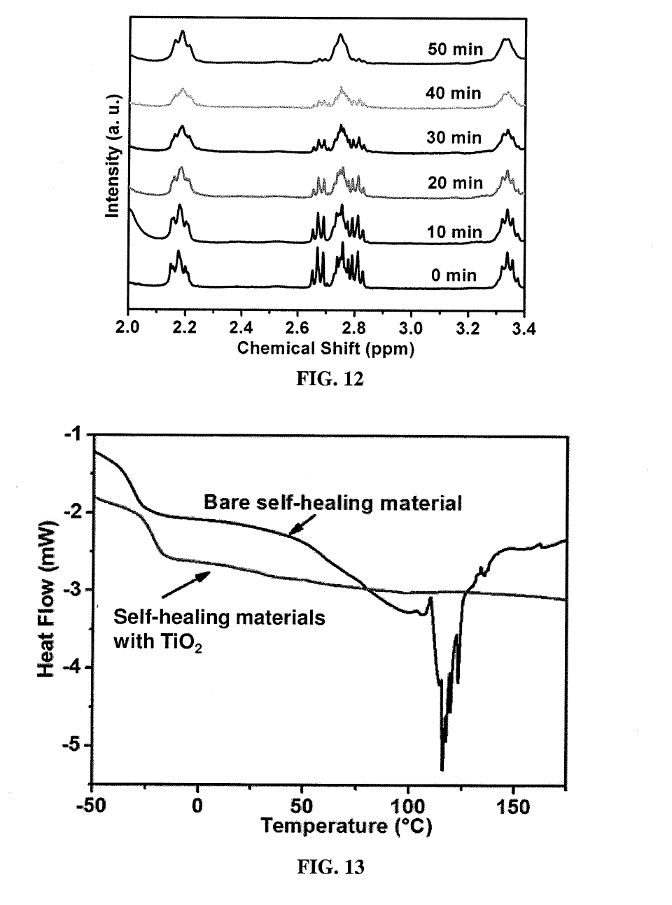

FIG. 12 depicts a graph of the High-resolution ¹H Nuclear Magnetic Resonance (NMR) spectra of the supramolecular network 110 on the reaction between the randomly branched polymer and urea at different reaction times. It shows that at 50 minutes, all the primary amines were converted into amide while the secondary amines were still present, indicating the formation of 3D supramolecular network. This 3D supramolecular network can endow the supramolecular materials with self-healing property. FIG. 13 depicts a graph of the differential scanning calorimetry (DSC) spectra of as-prepared self-healing composite 100 with added 47 wt % TiO₂ nanoflowers 114 and without any TiO₂ nanoflowers. The graph shows that the addition of TiO₂ nanoflowers 114 into the self-healing composite 100 was able to enhance or increase its glass transition temperature (Tg).

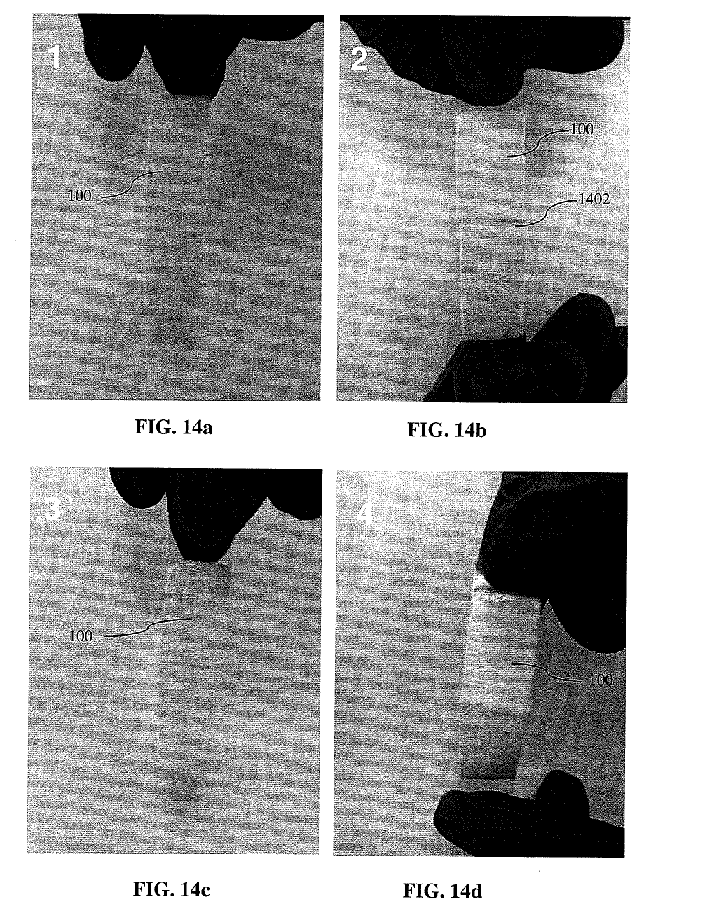

In an experiment, a self-healing composite 100 as shown in FIG. 14a comprising 47 wt % TiO₂ was cut in half as shown in FIG. 14b. The two separated portions were held together by applying a gentle pressure within 20 seconds of cutting and holding them constant for 5 minutes as shown in FIG. 14c at room temperature. This was found to sufficiently restore the mechanical strength and flexibility of the self-healing composite 100 as shown in FIG. 14d. This can be attributed to the dynamically association of reversible hydrogen bonds 112 at the damaged site 1402. In addition, the low Tg (under room temperature) of the self-healing composite 100 also facilitates the rearrangement and diffusion of the supramolecular chains on fractured interfaces, endowing the composite 100 with sufficient healing capability even at room temperature. However, it was found that the composite 100 healed under such conditions may be prone to be damaged again at the initial broken site 1402 as evident from FIG. 11.

In another experiment, two separated portions were held together by applying a gentle pressure within 20 seconds of cutting and holding them constant for 5 minutes but this time at an elevated temperature of 50° C. Under these conditions, the scar in the composite 100 due to the cut was found to be substantially healed. Quantitative tensile testing revealed that the mechanical behavior of the composite 100 can be nearly fully restored by subjecting it to a healing temperature of 50° C. for 5 min. Therefore, this demonstrates that applying an elevated healing temperature improves the healing capability of the composite 100.

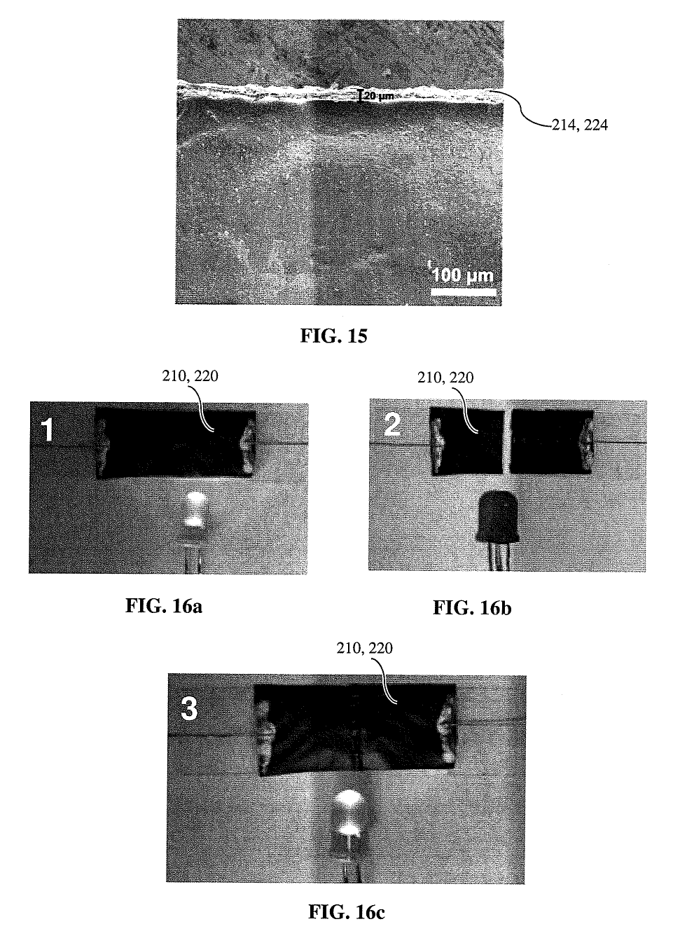

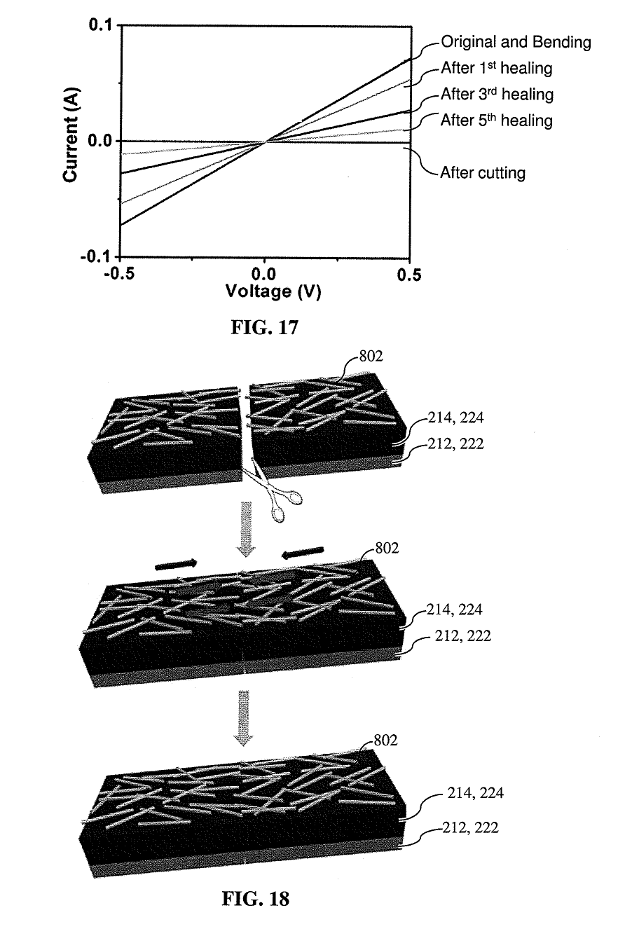

In a further experiment, after spreading the functionalized SWCNT films 214, 224 of thickness about 20 μm (sheet resistance: ˜0.9 Ωsq⁻¹) on the self-healing substrates (47 wt % TiO₂) 212, 222 as shown in FIG. 15, the healing capability with respect to the electrical conductivity for the as-prepared electrodes 210, 220 were investigated. In this experiment, a commercially available light-emitting diode (LED) bulb was employed for monitoring the conductive behavior of the electrode 210, 220 in a tandem circuit. As shown in FIGS. 16a and 16b, the lighted LED was extinguished when the electrode 210, 220 was cut. Thereafter, when a gentle pressure was applied within 20 seconds bringing together the two halves of the bifurcated electrode 210, 220, the LED would light up again as shown in FIG. 16c. The conductivities were also quantitatively characterized by a current-voltage (I-V) measurement. As shown in FIG. 17, the I-V curves of the original, bent, as well as healed electrodes are all linear and non-hysteretic, indicating their excellent conductive properties. The curves of the original and bent electrodes 210, 220 are overlapped, demonstrating their potential for flexible electronics. More importantly, these electrodes 210, 220 exhibit the characteristic of restorable electrical conductivity, i.e., the resistance is still in a low range even after the 5^{th} cutting. As explained hereinbefore, such healable electrical conductivity is resultant from the lateral movement of the underlying self-healing composition layer 212, 222, which brings separated portions/areas of the conductive film (e.g., SWCNT) layer 214, 224 into contact as schematically illustrated in FIG. 18.

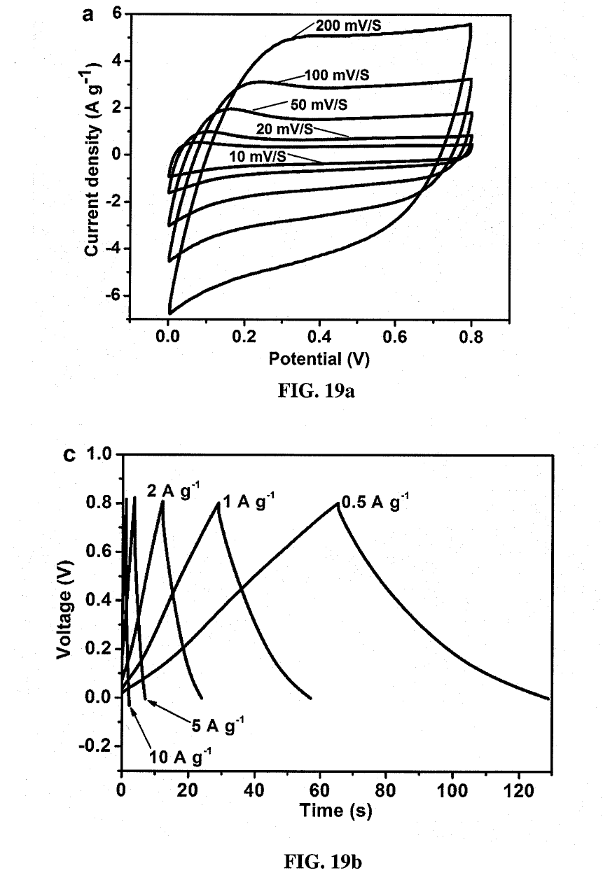

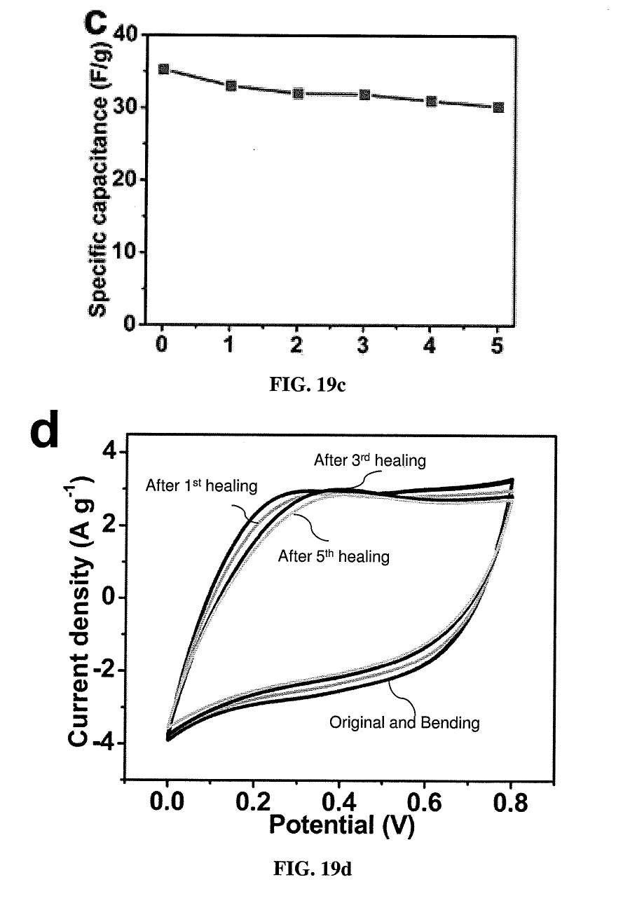

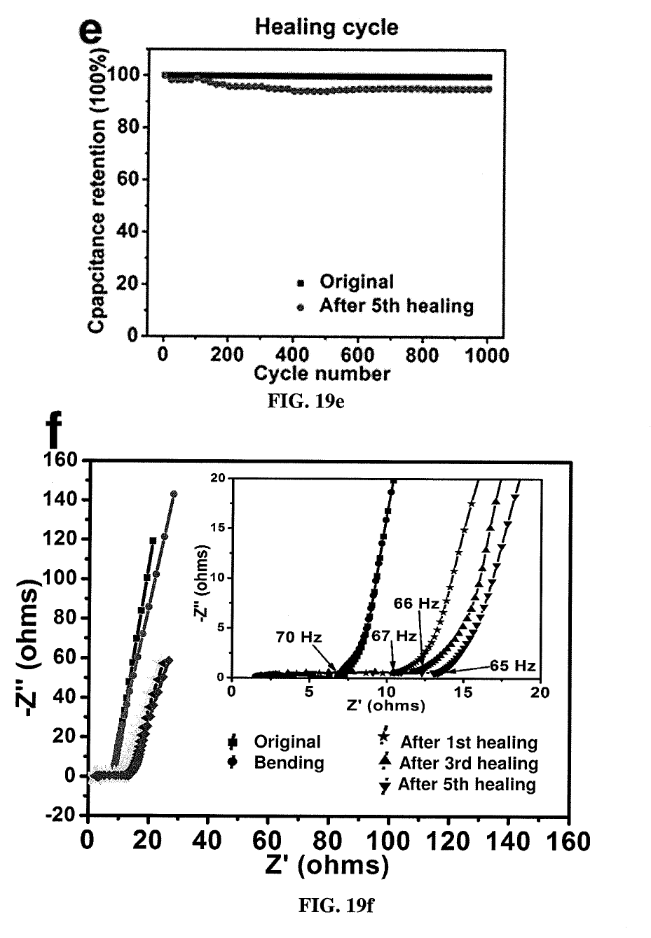

Furthermore, as a proof-of-concept, the electrochemical performance of the two-electrode symmetrical flexible supercapacitor cells 200 based on the as-prepared electrically self-healing SWCNT films 214, 224 was investigated. FIG. 19a shows the cyclic voltammetry (CV) curves of the supercapacitor device 200 in the voltage window from 0 to 0.8 V at various scan rates. The CV curves are close to rectangular even at a high scan rate of 200 mV s⁻¹, indicating an excellent capacitance behavior, which can be mainly attributed to electronic double-layer capacitance. The capacitances of the as-assembled supercapacitors 200 were further evaluated by galvanostatic charge/discharge tests at different current densities between 0 and 0.8 V. As shown in FIG. 19b, the linear profile and symmetric triangular shape of the galvanostatic charge and discharge curves suggest ideal capacitive characteristics.

The specific capacitances of the as-assembled supercapacitors 200 were calculated from their charge/discharge curves according to the following equation:

$$Csp = \frac{I \times Δ t}{Δ V} \qquad ( 1 )$$

where Csp (F g⁻¹) is the specific capacitance, I is the constant discharging current density, Δt is the discharging time, ΔV (V) is the voltage window.

The results of the above calculations are as follows. The calculated specific capacitance of the healable SWCNT film supercapacitor 200 according to the example embodiment is about 35 F g⁻¹ for a two-electrode cell at the current density of 1 A g⁻¹. This is consistent with the capacitance value of 35.6 F g⁻¹ obtained from CV testing at a scan rate of 20 mV s⁻¹, and is comparable to that of conventional functionalized or compact-designed SWCNT film supercapacitors. After cutting, the specific capacitances calculated from the discharge curves of the 1^{st} healing, 3^{rd} healing and 5^{th} healing, are 34, 32 and 30 F g⁻¹, respectively, and the capacitance retention ratio is about 85.7% after the 5^{th} healing, indicating a highly restorable capacitance behavior as shown in FIG. 19c. The CV curves in FIG. 19d show no obvious deviation when subjected to an inward ˜45° bending angle, suggesting that the capacitive behavior of the healable supercapacitor 200 remains nearly the same despite bending, which it turn demonstrates its potential for flexible-device applications. The capacitance of the healable supercapacitor 200 decreases gradually with increasing cycles of cutting and healing, but the CV curve remains largely rectangular even after the 5^{th} healing, with nearly 82.3% of the initial capacitance restored. This result is consistent with the charge/discharge test results. To elucidate the performance durability of the supercapacitors 200 before cutting and after the 5^{th} healing, 1000 charge/discharge cycles were performed on both supercapacitors 200 at a high current density of 5 A g⁻¹, as shown in FIG. 19e. Remarkably, nearly no degradation was observed for the supercapacitors 200 prior to cutting, and only 3.6% decay in specific capacitance was observed for the supercapacitors 200 after the 5^{th} healing, which demonstrate the excellent electrochemical stability of the self-healing supercapacitors 200 according to embodiments of the present invention.

Finally, the electrochemical impedance spectroscopy (EIS) was used to further study the electrochemical behaviors of the self-healing supercapacitors 200, and the Nyquist plots are shown in FIG. 19f. In the low frequency region, the original Nyquist plot is nearly perpendicular to the real axis, which indicates purely capacitive behaviors. Only a subtle deviation was seen in the EIS spectra under bending of the supercapacitors 200, suggesting little change in the interior contact resistance and energy storage capabilities. The equivalent series resistances (ESR) of the capacitors before cutting and after the 1^{st}, 3^{rd} and 5^{th} healing are 4.8, 9.8, 13.1, 15.2Ω, respectively, signifying that the internal resistance of electrode materials increases after healing. These results are consistent with that obtained via I-V measurement. The knee frequency on Nyquist plots indicates the upper limit of the frequency below which the double-lay supercapacitors begin to store energy. It can be seen that the knee frequency only decreased from the original value of 70 Hz to 65 Hz after the 5^{th} healing, which suggests their similar physisorption behavior with respect to electrolyte ions, and energy-storage capacities.

Accordingly, an integrated mechanically and electrically self-healing supercapacitor 200 may be obtained according to an example embodiment by spreading functionalized SWCNT films 214, 224 on self-healing substrates 212, 222. The electrical conductivity of the SWCNT films 214, 224 can be restored by the lateral movement of the underlying self-healing composition layer 212, 222, which brings the separated portions/areas of the SWCNT layer 214, 224 back into contact. The flexible solid-state supercapacitors 200 with electrodes 210, 220 composed of these electrically self-healing SWCNT films 214, 224 exhibit excellent self-healing performance. For example, as demonstrated above, the specific capacitance can be restored by up to 85.7% even after the 5^{th} cutting.

In a further embodiment, the restoration performance was further improved by incorporating nano- or micro-particles in the supramolecular network 100, such as micro-nickel particles, thereby making the self-healing substrates 212, 222 conductive. For example, the large size of the spherical particles can lead to a reduction in phase aggregation, while the nanometre-scale corrugated surface provides an adequate surface area for wetting. In addition, the thin native oxide layer on the particles can provide an affinity for hydrogen bonds in the supramolecular network 100.

### EXPERIMENTAL SECTION

### Preparation of the Self-Healing Substrates 212, 222

The self-healing composite 100 was prepared by a modified Leibler's method. In brief, 4.15 g of Empol 1016 (donated by COGNIS, 80 wt % diacids, 16 wt % triacids) and 1.7 g diethylenetriamine (DETA, SIGMA-ALDRICH) were kept at a concrete temperature of 160° C. for 24 hours under intensive magnetic stirring and a nitrogen atmosphere. The product was then dissolved in 20 mL chloroform followed by washing with 20 mL water and 10 mL methanol, followed by the vacuum removal of chloroform. The oligomer was dissolved in 1 mL of chloroform and then mixed with TiO₂ nanoflowers 114 to obtain a homogeneous suspension. The suspension was then reacted with 30 mg urea (SIGMA-ALDRICH) at 135° C. under constant mechanical stirring for 50 minutes to form the self-healing composite 100. Subsequently, the self-healing composition 100 can be thermally compressed and self-adhered on various hydrophilic substrates, such as flexible polyethylene terephthalate (PET) sheets. The synthesis of hierarchical TiO₂ nanoflowers 114 was prepared by a modified method based on the disclosure of Wang et al., Rutile TiO2 nano-branched arrays on FTO for dye-sensitized solar cells, Phys. Chem. Chem. Phys. 13, 6977-6982 (2011), the content of which is incorporated herein by reference in their entirety for all purposes. An aqueous solution of 0.2 M TiCl₄ was sealed in a bottle and kept at a constant temperature of 40° C. for 24 hours. The TiO₂ nanoflower products were collected by centrifugation, washed several times with ethanol and dried in air at 50° C.

### Preparation of the SWCNT film 214, 224

The acid treatment method to obtain functionalized SWCNT dispersions have been described in literature such as in Shen et al., How carboxylic groups improve the performance of single-walled carbon nanotube electrochemical capacitors?, Energy Environ. Sci. 2011, 4, 4220-4229, the content of which is incorporated herein by reference in their entirety for all purposes. In brief, SWCNTs were firstly refluxed with concentrated nitric acid to graft carboxylic groups onto their surfaces, and then filtered and washed by a large amount of distilled water until the PH value is nearly neutral. These SWCNTs were subsequently dispersed into water by magnetic stirring, followed by centrifugation at 4000 g for 1 hour. The supernatant was decanted, and the black carbon sediments were dispersed in water again under sonication for 1 hour. The SWCNT dispersions were finally further centrifuged at 35,000 g for 1 hour to remove large bundles, and the supernatant containing well dispersed SWCNTs was achieved. To obtain a uniform SWCNT thin film 214, 224, the as-prepared SWCNT suspension was filtered through a porous alumina filtration membrane (pore size, 200 nm; Whatman). The resultant SWCNT film 214, 224 was formed after drying in air, and then gently peeled off from the filtration membrane.

### Fabrication of Self-Healing Supercapacitors 200

The self-healing supercapacitor 200 was assembled in a symmetric two-electrode configuration by using the SWCNT films 214, 224 as the active material and current collectors, as well as the PVP-H₂SO₄ gel electrolyte 230 as both an electrolyte and separator. The as-prepared SWCNT films 214, 224 were first cut into rectangular strips (1.5×3.5 cm²) and then were spread onto the self-healing substrates 212, 222. Next, the PVP-H₂SO₄ gel electrolyte 230 was prepared by adding 1 g H₂SO₄ and 1 g PVP powder into 10 mL deionized water. The mixture was kept at 85° C. under magnetic stirring until the solution became clear. The PVP-H₂SO₄ aqueous solution was then slowly poured on the SWCNT films 214, 224 with the selected areas about 1×3 cm², and dried at room temperature for 12 hours. Subsequently, the two electrodes 210, 220 were pressed together, and the gel electrolyte 230 on each electrode 210, 220 became glued into a single thin separating layer, resulting in the fabrication of an integrated supercapacitor 200. It will be appreciated that the sandwiched configuration was slightly staggered for the easy monitoring of SWCNT locations during the healing process. In practice, this staggered configuration not necessary.

Characterizations and Electrochemical Tests:

The morphologies were investigated by the field-emission gun scanning electron microscope ((JSM-7600F from JEOL, 5 KV) and transmission electron microscopy (JEM-2010F from JEOL, 200 KV). The X-ray diffraction (XRD) pattern of the as-prepared TiO₂ nanoflowers 114 was recorded by a BRUKER-AXS X-ray diffractometer with Cu Kα radiation (λ=1.5418 Δ). High-resolution ¹H Nuclear Magnetic Resonance (NMR) spectra of the supramolecular networks were collected with a Bruker 300 MHz spectrometer. Differential scanning calorimetry (DSC) of the self-healing based materials was recorded on a TA Instruments DSC Q10 using N₂ as purge gas at a heating rate 10° C./min. Tensile-stress measurements of as-prepared self-healing composites 100 were carried out by an INSTRON 5567 Microtester. The sheet resistance of the SWCNT film 214, 224 was measured by a 4200-SCS Semiconductor Characterization System. The intensity versus potential (I-V curve) measurements of the SWCNT film (1×2 cm²) 214, 224 were recorded by a KEITHLEY 4200 semiconductor characterization system. Cyclic voltammetry and galvonostatic charge-discharge measurements of the self-healing supercapacitors 200 were carried out on a supercapacitor test system (SOLARTRON, 1470E) within the voltage range from 0 to 0.8 V. Electrochemical impedance spectroscopy (EIS) was measured on a potentiostat (CHI 660D, CH Instruments) over the frequency range of 10⁻¹ to 10⁵ Hz with a 10 mV amplitude.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A self-healing composite comprising:
a supramolecular polymeric network of molecules cross-linked through reversible bonds; and
nanostructures incorporated into the supramolecular polymeric network, the nanostructures and the supramolecular polymeric network being cross-linked through reversible bonds,
wherein the supramolecular network has a glass transition temperature of about 10° C. to about 50° C.

2. The self-healing composite according to claim 1, wherein the nanostructures comprise flower-like nanostructures.

3. The self-healing composite according to claim 1, wherein the nanostructures are made of TiO₂, SiO₂, or Ni.

4. The self-healing composite according to claim 1, wherein the amount of nanostructures in the supramolecular polymeric network is about 45 wt % to about 53 wt %.

5. The self-healing composite according to claim 4, wherein the amount of nanostructures in the supramolecular polymeric network is about 47 wt %.

6. The self-healing composite according to claim 1, wherein the reversible bonds are selected from the group consisting of hydrogen bonds, host-guest interaction, π-π interaction, and hydrophobic interaction.

7. The self-healing composite according to claim 1, wherein the reversible bonds between the nanostructures and the supramolecular polymeric network are based on carbonyl functional groups and/or NH functional groups from the supramolecular polymeric network.

8. A self-healing supercapacitor comprising:
a first electrode comprising a first substrate and a first conductive film disposed on the first substrate;
a second electrode comprising a second substrate and a second conductive film disposed on the second substrate; and
a separating layer disposed between the first and second electrodes,
wherein at least one of the first and second substrates comprises a self-healing composite including:
a supramolecular polymeric network of molecules cross-linked through reversible bonds; and
nanostructures incorporated into the supramolecular polymeric network, the nanostructures and the supramolecular polymeric network being cross-linked through reversible bonds,
wherein the supramolecular network has a glass transition temperature of about 10° C. to about 50° C.

9. The self-healing supercapacitor according to claim 8, the first and second conductive films each comprises elongated nanostructures dispersed on the respective first and second substrates.

10. The self-healing supercapacitor according to claim 9, wherein the elongated nanostructures are selected from the group consisting of carbon nanowires, carbon nanotubes and carbon nanorods.

11. The self-healing supercapacitor according to claim 8, wherein the separating layer comprises a gel polymer electrolyte configured to bond the first and second conductive films together and provide a conductive connection between the first and second electrodes.

12. The self-healing supercapacitor according to claim 11, wherein the gel polymer electrolyte is selected from the group consisting of polyvinyl pyrrolidone-sulphuric acid (PVS-H₂SO₄), poly(ethylene oxide)-LiBF₄, and poly(acrylonitrile)-LiClO₄.

13. A method of fabricating a self-healing composite, the method comprising:
forming a supramolecular polymeric network of molecules cross-linked through reversible bonds; and
incorporating nanostructures into the supramolecular polymeric network and cross-linking the nanostructures and supramolecular polymeric network through reversible bonds,
wherein the supramolecular network has a glass transition temperature of about 10° C. to about 50° C.

14. The method according to claim 13, wherein the nanostructures comprise flower-like nanostructures.

15. The method according to claim 13, wherein the nanostructures are made of TiO₂, SiO₂, or Ni.

16. The method according to claim 13, wherein the amount of nanostructures in the supramolecular polymeric network is about 45 wt % to about 53 wt %.

17. The method according to claim 16, wherein the amount of nanostructures in the supramolecular polymeric network is about 47 wt %.

18. The method according to claim 13, wherein the reversible bonds are selected from the group consisting of hydrogen bonds, host-guest interaction, π-π interaction, and hydrophobic interaction.

19. The method according to claim 13, wherein the reversible bonds between the nanostructures and the supramolecular polymeric network are selected based on carbonyl functional groups and/or NH functional groups from the supramolecular polymeric network.

20. A method of fabricating a self-healing supercapacitor, the method comprising:
forming a first electrode comprising a first substrate and a first conductive film disposed on the first substrate;
forming a second electrode comprising a second substrate and a second conductive film disposed on the second substrate; and
forming a separating layer disposed between the first and second electrodes, wherein at least one of the first and second substrates comprises a self-healing composite comprising:
a supramolecular polymeric network of molecules cross-linked through reversible bonds; and
nanostructures incorporated into the supramolecular polymeric network, the nanostructures and the supramolecular polymeric network being cross-linked through reversible bonds,
wherein the supramolecular network has a glass transition temperature of about 10° C. to about 50° C.

21. An electrode comprising:
a self-healing substrate; and
a conductive film disposed on the self-healing substrate;
wherein the self-healing substrate comprises a self-healing composite including:
a supramolecular polymeric network of molecules cross-linked through reversible bonds; and
nanostructures incorporated into the supramolecular polymeric network, the nanostructures and the supramolecular polymeric network being cross-linked through reversible bonds,
wherein the supramolecular network has a glass transition temperature of about 10° C. to about 50° C.
